(19) United States
(12) Patent Application Publication
(10) Pub. No.: US 2025/0324469 A1
(43) Pub. Date: Oct. 16, 2025

(54) DIRECTIONAL D2D COMMUNICATION

(71) Applicant: Telefonaktiebolaget LM Ericsson (publ), Stockholm (SE)

(72) Inventors: Peter Okvist, Lulea (SE); Niklas Jalden, Enkoping (SE)

(21) Appl. No.: 18/865,546

(22) PCT Filed: May 13, 2022
(86) PCT No.: PCT/SE2022/050470

§ 371 Date: Nov. 13, 2024

(51) Int. Cl. H04W 76/14; H04B 7/06; H04B 17/318; H04L 5/00; H04W 24/08

(52) U.S. Cl. CPC H04W 76/14; H04B 7/0626; H04B 17/318; H04L 5/0051; H04W 24/08

(57) ABSTRACT

The present disclosure relates to a method of a wireless communication device (201) of performing direct communication with at least one other wireless candidate communication device (202) in a wireless communication system, and a wireless communication device (201) performing the method. Further disclosed is a computer program (122) and a computer program product (123). The method comprises monitoring (S201) reference signals from wireless candidate communication devices (202, 203, 204), determining (S202), from the monitored reference signals, a direction from said wireless communication device (201) to the wireless candidate communication device (202, 203, 204) associated with each monitored reference signal, determining (S203) transmission parameters for data to be communicated to at least one selected wireless candidate communication device (202) of the wireless candidate communication devices (202, 203, 204) based on the determined direction to the selected wireless candidate communication device (202), and transmitting (S204) data to the at least one selected wireless candidate communication device (202) over an established direct communication path by applying the determined transmission parameters for the transmitted data.

### TECHNICAL FIELD

The present disclosure relates to a method of a wireless communication device of performing direct communication with at least one other wireless candidate communication device in a wireless communication system, and a wireless communication device performing the method. Further disclosed is a computer program and a computer program product.

### BACKGROUND

Device-to-device (D2D), or proximity-based, direct communication between mobile device is gaining interest by interested parties for connecting devices.

D2D communication typically involves direct communication between two mobile users without traversing a base station or a core network (other than possibly for initially enabling establishment of a direct path between the two devices).

One driving force for D2D connectivity is the inherent flexibility for operators to offload traffic from the core network and thus represents a way for operators to reduce energy and cost particularly for supporting proximity-based services. Typical applications range from public safety, traffic control/safety and commercial services like proximity-based social networking, gaming, and advertisements for by-passers.

A problem occurring in D2D connectivity is how to identify and establish a direct communication path with an appropriate neighbouring device.

### SUMMARY

One objective is to solve, or at least mitigate, this problem in the art and thus to provide an improved method of a wireless communication device of performing direct communication with one or more other wireless candidate communication devices.

This objective is attained in a first aspect by a method of a wireless communication device of performing direct communication with at least one other wireless candidate communication device in a wireless communication system. The method comprises monitoring reference signals from wireless candidate communication devices, determining from the monitored reference signals a direction from said wireless communication device to the wireless candidate communication device associated with each monitored reference signal and determining transmission parameters for data to be communicated to at least one selected wireless candidate communication device of the wireless candidate communication devices based on the determined direction to the selected wireless candidate communication device. The method further comprises transmitting data to the at least one selected wireless candidate communication device over an established direct communication path by applying the determined transmission parameters for the transmitted data.

This objective is attained in a second aspect by a wireless communication device configured to perform direct communication with at least one other wireless candidate communication device in a wireless communication system, which wireless communication device comprises a processing unit and a memory. The memory contains instructions executable by the processing unit, whereby the wireless communication device is operative to monitor reference signals from wireless candidate communication devices, determine from the monitored reference signals a direction from said wireless communication device to the wireless candidate communication device associated with each monitored reference signal, and to determine transmission parameters for data to be communicated to at least one selected wireless candidate communication device of the wireless candidate communication devices based on the determined direction to the selected wireless candidate communication device. The wireless communication device is further operative to transmit data to the at least one selected wireless candidate communication device over an established direct communication path by applying the determined transmission parameters for the transmitted data.

Thus, the wireless communication device will determine from monitored reference signals of candidate communication devices a direction to one or more of the candidate communication devices with which communication is to be performed.

After having determined the direction to a candidate device, transmission parameters is determined for data to be communicated. For instance, the wireless communication device may determine that the candidate device is located right behind and will thus e.g. use a rearwardly directed antenna panel of an antenna array to transmit the data to the candidate device over an established direct communication path.

Advantageously, this would improve quality of the signals received over direct communication paths—referred to as sidelinks—established between the wireless communication device and the candidate wireless communication device, e.g. in that signal-to-noise ratio (SNR) of the signals received is improved. Further, any interference caused to a device not being an intended target for transmitted signals is typically reduced.

In an embodiment, the wireless candidate communication devices being monitored are located in proximity of the wireless communication device.

In an embodiment, the wireless candidate communication devices being monitored and the wireless communication device are configured to be served by a common radio base station.

In an embodiment, the determining of transmission parameters for data to be communicated to the at least one selected wireless candidate communication device comprises determining a direction in which to transmit the data to the at least one selected wireless candidate communication device.

In an embodiment, the reference signals being monitored comprise Sounding Reference Signals (SRSs).

In an embodiment, it is further determined whether or not a strength of each monitored reference signal exceeds a signal strength threshold value, and if so, it is determined, from the monitored reference signals, a direction from said wireless communication device to the wireless candidate communication device associated with said each monitored reference signal.

In an embodiment, channel state information (CSI) is further determined for the direct communication path established with the at least one selected wireless candidate communication device, wherein the determining of transmission parameters for data to be communicated to at least one selected wireless candidate communication device of the wireless candidate communication devices further is based on the determined channel state information.

In an embodiment, previously determined transmission parameters are reused if the determined direction of a candidate communication device is similar to a previously determined direction of another candidate device.

In an embodiment, the wireless communication device is arranged with antenna panels being directed in different directions, wherein the direction to a wireless candidate communication device is determined by evaluating on which one or more of the antenna panels a reference signal is received.

This objective is attained in a third aspect by a computer program comprising computer-executable instructions for causing a wireless communication device to perform steps of the method of the first aspect when the computer-executable instructions are executed on a processing unit included in the wireless communication device.

This objective is attained in a fourth aspect by a computer program product comprising a computer readable medium, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a simplified prior art architecture or D2D proximity-based direct communication;

FIG. 2 shows a prior art signalling diagram illustrating establishment of direct communication between two wireless communication devices;

FIG. 3 illustrates a scenario in which embodiments may be implemented;

FIG. 4 shows a flowchart illustrating a method according to an embodiment;

FIG. 5 shows a flowchart illustrating a method according to another embodiment;

FIG. 6 shows a flowchart illustrating a method according to a further embodiment;

FIG. 7 shows a flowchart illustrating a method according to yet an embodiment; and

FIG. 8 illustrates a wireless communication device according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

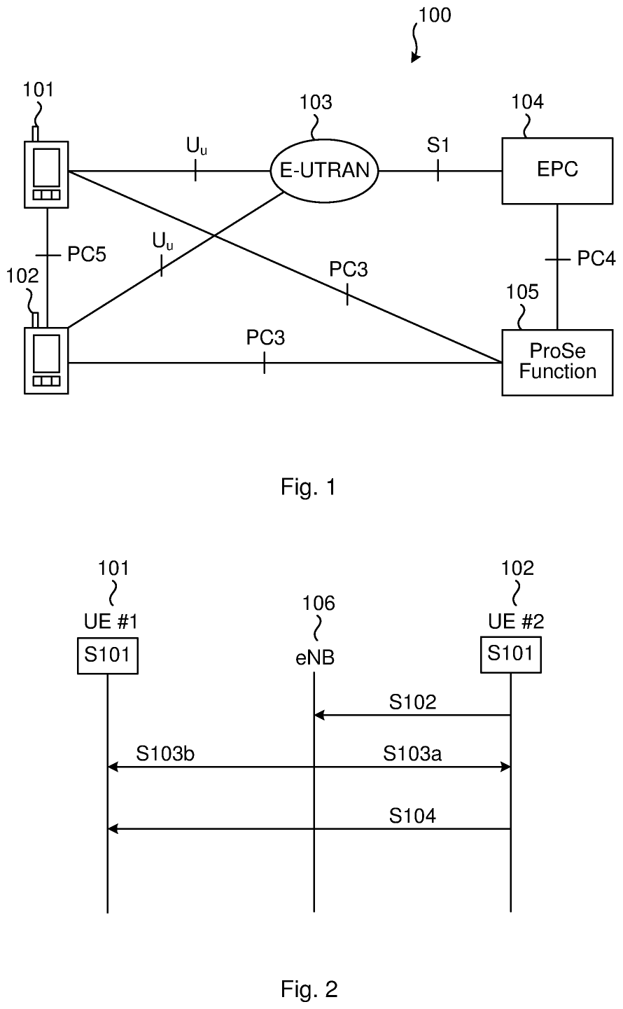

FIG. 1 illustrates a simplified prior art architecture 100 for D2D proximity-based direct communication. D2D direct communication may be applied in various generations radio access technologies (RATs), such as 2G, 3G, 4G and 5G technologies—e.g. Global System for Mobile Communications (GSM), Universal Mobile Telecommunications System (UMTS), Long Term Evolution (LTE) and New Radio (NR). In this example, the D2D direct communication is illustrated to occur in an LTE system.

Thus, two wireless communication devices 101, 102 referred to as User Equipment (UE) in the form of e.g. smart phones, tablets, gaming consoles, connected vehicles, etc., may establish a direct communication path PC5 with each other.

As further illustrated in FIG. 1, the two UEs 101, 102 are connected via interface Uᵤ to a radio access network 103 referred to as Evolved Universal Terrestrial Radio Access Network (E-UTRAN) which in its turn is connected via interface S1 to a core network 104 of the LTE system, Evolved Packet Core (EPC).

Moreover, the two UEs 101, 102 are connected via interface PC3 to a Proximity Services (ProSe) function 105 responsible for enabling direct discovery and communication between the two UEs 101, 102. The ProSe function 105 is connected to the EPC 104 via interface PC4.

As the name implies, proximity-based services may be provided when UEs are in a vicinity of each other. An approach referred to as direct discovery is applied for identifying that two UEs 101, 102 are in proximity of each other, and direct communication between the two UEs 101, 102 is effected in that resources from cellular traffic may be reserved and used for this type of communication, or enables communication in areas without cellular coverage.

The PC5 interface is commonly referred to as the sidelink and is used by the two UEs 101, 102 to communicate directly with each other without passing over a base station located in the E-UTRAN 103.

To establish direct communication via the PC5 interface, the UEs 101, 102 contact the ProSe function 105 using the PC3 interface. An internet protocol (IP) address of the ProSe function 105 may be preconfigured in the UEs 101, 102. Alternatively, the UEs 101, 102 identify the IP address of the ProSe function 105 via Domain Name System (DNS) look-up. To contact the ProSe function 105, the UEs 101, 10 establish a Radio Resource Control (RRC) connection with the radio access network 103.

In a prior art D2D communication architecture such as that illustrated with reference to FIG. 1, beamforming is not applied which may result in a poor-quality communication path being established between the two UEs 101, 102 over interface PC5, which further may cause interference to other UEs.

FIG. 2 shows a prior art signalling diagram illustrating establishment of direct communication between the two UEs 101, 102, where both UEs are in a coverage area of the radio base station 106 (referred to as eNB in an LTE system) in the E-UTRAN 103.

In a first initial step S101 upon the two UEs 101, 102 entering the coverage area of the eNB 106 (or are being powered on while being located in the coverage area), the eNB 106 may inform the two UEs 101, 102—and any other UE located within the area—that the eNB 106 indeed is D2D-capable. In LTE, such information is communicated via system information block (SIB) 18. For vehicles, assuming for instance that the UEs are connected cars, D2D communication is commonly referred to as vehicle-to-everything (V2X) communication.

In step 102, second UE 102 requests permission from the eNB 106 to be allocated resources for establishing a direct connection with first UE 101, i.e. to establish a sidelink over PC5.

In response to the request, the eNB 106 indicates resource allocation for the first UE 101 and second UE 102. Thus, the eNB 106 acknowledges in step S103a that the second UE 102 is being allocated resources for direct communication over PC5 and further instructs the first UE 101 in step 103b not to use certain uplink (UL) resources for own transmissions since a potential incoming transmissions over PC5 (allocated on UL resources) could be expected from the announcing second UE 102.

Thereafter, in step S104, the second UE 102 transmit data to the first UE 101 in step S104 over the established sidelink. Thus, other than having the eNB 106 handle the initiating of the sidelink in steps S101, S102, S103a and S103b, the first UE 101 and the second UE 102 are advantageously free to communicate over the established sidelink as illustrated in step S104. As is understood, such direct communication between the first UE 101 and the second UE 102 may involve many rounds of data being exchange between the two (or submitted from one of the UEs to the other) without having to pass over the eNB 106.

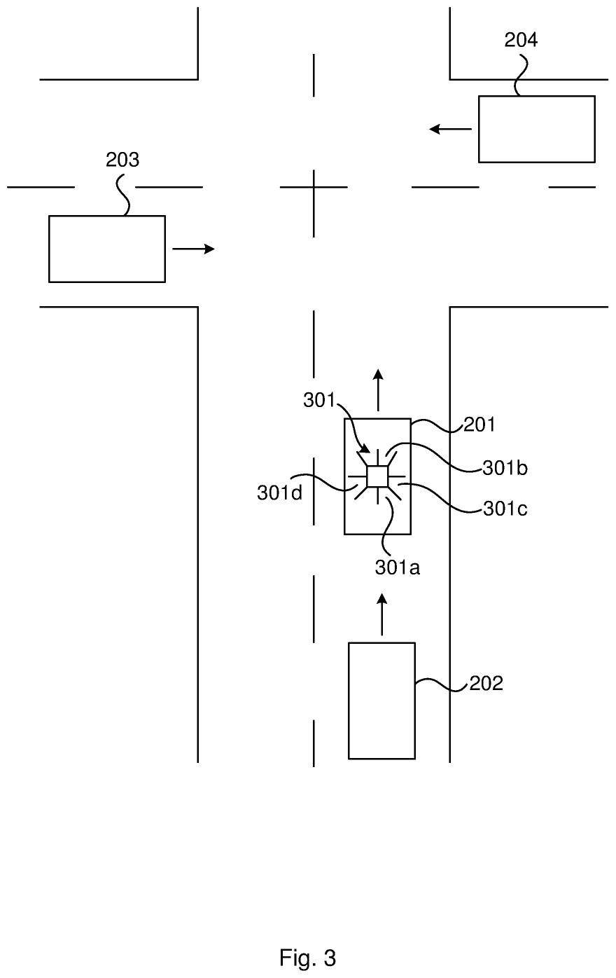

FIG. 3 illustrates a UE 201 in the form of a connected vehicle, which UE 201 may wish to communicate with one or more other potential UEs in its surroundings. The one or more other UEs are referred to as candidate UEs and will also be illustrated in the form of connected vehicles.

Now, the vehicle 201, referred to in the following as ego vehicle, may be equipped with an antenna system 301 where signals e.g. may be directed in front of the ego vehicle 201, behind the ego vehicle 201, or to the right or the left of the ego vehicle 201. In other words, in this embodiment, the ego vehicle 201 is capable of performing beamforming, i.e. to selectively direct a signal to be transmitted in a preferred direction.

Assuming for instance that the ego vehicle 201 performs (or is about to perform) a braking action; it would thus be beneficial to communicate such action at least to a vehicle 202 being located immediately behind the ego vehicle 201 such that vehicle 202 behind the ego vehicle 201 quickly can respond (and possibly in its turn inform yet another vehicle). This is particularly advantageous in case the vehicles are autonomous vehicles.

In another scenario, the ego vehicle 201, being for instance an emergency vehicle, approaches a junction at high speed and wishes to alert other vehicles 203, 204 approaching the junction of the ongoing emergency event.

As is understood, in case of a braking action, the ego vehicle 201 would preferably transmit a corresponding alert signal via its backwards directed antenna 301a, while in case of approaching the junction, an alert signal would be sent to the vehicle 204 located on a right-hand side via front antenna panel 301b and/or right antenna panel 301c and to the vehicle 203 located on a left-hand side via front antenna panel 301b and/or left antenna panel 301d.

Advantageously, this would improve quality of the signals received over direct communication paths—i.e. sidelinks—established between the ego vehicle 201 and the other vehicles 202, 203, 204, e.g. in that signal-to-noise ratio (SNR) of the signals received is improved. Further, any interference caused to a vehicle not being an intended target for transmitted signals is typically reduced.

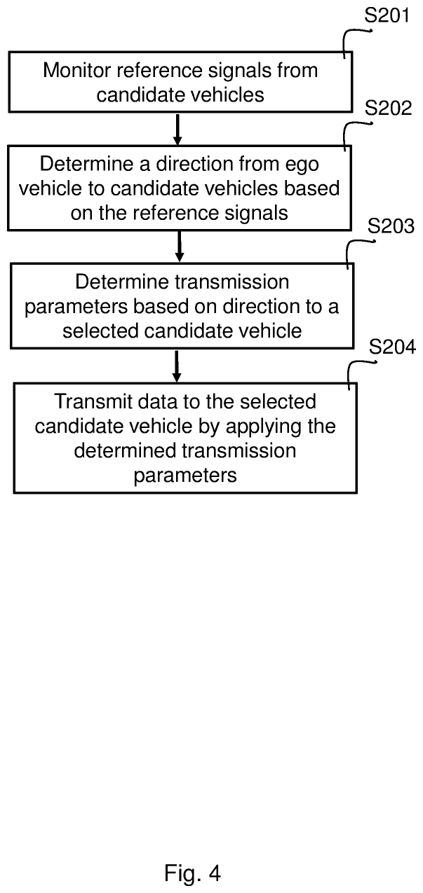

FIG. 4 shows a flowchart illustrating a method performed by a wireless communication device, i.e. ego vehicle 201, of performing direct communication with at least one other wireless candidate communication device.

In a first step S201, the ego vehicle 201 monitors reference signals from candidate vehicles 202, 203, 204 in its surroundings. In this particular exemplifying embodiment there are three candidate vehicles, but in practice tens of even hundreds of candidate vehicles may be present in the surroundings of the ego vehicle 201. In practice, the ego vehicle 201 will typically continuously poll any reference signals transmitted by the candidate vehicles 202, 203, 204.

In an embodiment, the ego vehicle 201 potentially monitors reference signals of all candidate vehicles being in a coverage area provided by a radio base station (RBS) serving the area. In other words, the ego vehicle 201 monitors reference signals of all candidate vehicles being served by the same RBS as the ego vehicle 201.

In another embodiment, the ego vehicle 201 will consider reference signals having sufficient strength (such as exceeding a signal strength threshold value), since the ego vehicle 201 is not likely to wish to communicate with vehicles located on a great distance from the ego vehicle 201. In other words, the ego vehicle 201 typically only wants to communicate with a candidate vehicle located in proximity of the ego vehicle.

In an embodiment, the reference signal being monitored is a so-called Sounding Reference Signal (SRS). In order for the ego vehicle 201 to be able to estimate direct communication channel characteristics to the candidate vehicles 202, 203, 204, the candidate vehicles may be instructed to (periodically or aperiodically) send an uplink (UL) reference signal referred to as an SRS based on which the ego vehicle 201 can estimate the respective channel characteristic upon receiving the SRS. For instance, from the SRSs, the ego vehicle 201 may estimate signal-to-interference-plus-noise ratio (SINR), attenuation, phase-shift, noise, etc., of the channel.

Further, the ego vehicle 201 determines in step S202 a direction to each candidate vehicle 202, 203, 204 from each received SRS. In other words, the SRS enables the ego vehicle 201 to position the candidate vehicle associated with each SRS. With the setup of FIG. 3, the ego vehicle 201 may determine at which antenna panel 301a-301d a reference signal is received and thus estimate a direction to a candidate vehicle. For instance, if an SRS of a particular candidate vehicle is received at the right-hand antenna panel 301c, the ego vehicle 201 may conclude that said particular candidate vehicle is located to the right of the ego vehicle 201. Typically, the more antenna panels being present in the antenna system 301, the higher the spatial resolution when determining candidate vehicle direction, and a fairly precise angle to a candidate vehicle may thus be determined by evaluating on which one or more of the antenna panels the SRS is received.

In this example, it is assumed that a braking operation is performed by the ego vehicle 201 as previously discussed. As a result of the braking operation being performed, the ego vehicle 201 will alert one or more of the candidate vehicles accordingly (preferably preceding the braking operation).

In this particular embodiment, the ego vehicle 201 selects the candidate vehicle 202 located behind the ego vehicle 201 for transmitting a braking alert signal via a direct communication path. The braking alert may comprise detailed information regarding the braking operation, indicating e.g. a deacceleration metric or an estimated stopping distance given current speed.

In step S203, the ego vehicle 201 determines transmission parameters for the braking alert signal to be communicated to the selected candidate vehicle 202 based on the determined direction to the selected candidate vehicle 202, and transmits the braking alert signal to the selected candidate vehicle 202 in step S204 over an established direct communication path by applying the determined transmission parameters for the transmitted braking alert signal. As is understood, the candidate vehicle 202 may reply with an acknowledgement (ACK) in case the braking alert signals is successfully received, or a non-acknowledgement (NACK) in case the signal is not received).

In this particular example, the determination of transmission parameters includes determining via which antenna panel the braking alert is to be transmitted, i.e. via the back antenna panel 301a.

However, the determination of transmission parameters may include determination of multiple transmission parameters including one or more of determining suitable frequency bands, modulation and coding schemes, multiple-input and multiple-output (MIMO) configurations, precoder setups, beamforming configurations, amount of radio resources being assigned for transmission, etc.

By carefully selecting transmission parameters based on the direction to the selected candidate vehicle 202 from the ego vehicle 201, quality of the established direct path to the candidate vehicle 202 may be greatly improved. In the exemplifying embodiment of FIG. 3, by directing the transmission of the braking alert signal towards the candidate vehicle 202 via the back antenna panel 301a, the SNR of the received signal is typically greatly improved. Further advantageous is that the directing of the transmitted braking alert signal will avoid causing interference to the other candidate vehicles 203, 204.

Advantageously, a direction-aware interference-suppressing transmission scheme is provided for D2D communication, and enables a device to more efficiently target which other devices to communicate with given a certain intention associated with the transmission.

Further, devices not being targets of a direct path communication are not affected—and are not subjected to interference—which further provides for a less congested D2D interface.

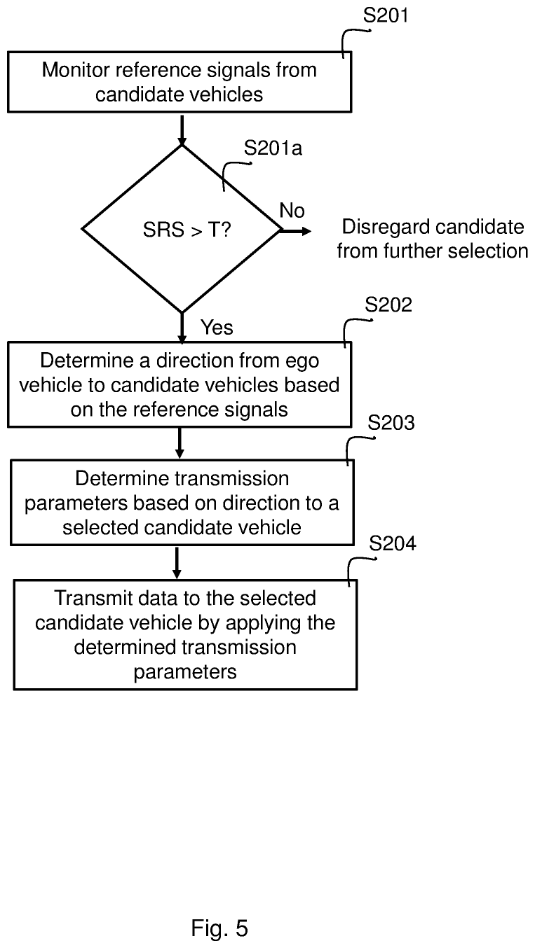

In an embodiment illustrated with reference to FIG. 5, as mentioned hereinabove, after having monitored SRSs in step S201, the ego vehicle 201 determines in step S201a whether or not a strength of each SRS exceeds a signal strength threshold value T. If not, the candidate vehicle associated with the SRS will be disregarded from further selection.

Assuming in an example that the ego vehicle 201 is an emergency vehicle approaching the junction as illustrated in FIG. 3, and further that tens of candidate vehicles are in the surroundings of the ego vehicle 201 (not shown in FIG. 3) but that the only candidate vehicles being close to the junction are the three candidate vehicles 202, 203, 204 present in FIG. 3, to which an emergency alert signal is to be provided by the ego vehicle 201.

Thus, these three candidate vehicles are the only vehicles for which the SRS strength exceeds the threshold value T and as a result will be considered for further selection.

In step S202, the ego vehicle 201 determines a direction to each candidate vehicle 202, 203, 204 from each received SRS.

In this particular embodiment, the ego vehicle 201 selects the candidate vehicles 203, 204 approaching the junction (and possibly also the candidate vehicle 202 located behind the ego vehicle 201) for transmitting an emergency alert signal via a respective direct communication path established with each of the selected candidate devices 202, 203, 204. The emergency alert may comprise detailed information such as e.g. estimated time of arrival, speed, vehicle attributes such as curb weight, etc. In another example, it may be beneficial that the alert comprises information indicating cargo type; for instance a truck carrying a hazardous chemical cargo may entail a greater security distance than a truck carrying timber even if the curb weight may be similar.

In step S203, the ego vehicle 201 determines transmission parameters for the emergency alert signal to be communicated to the selected candidate vehicles 202, 203, 204 based on the determined direction to the selected candidate vehicles 202, 203, 204 and transmits the emergency alert signal to the selected candidate vehicles 202, 203, 204 in step S204 over a respective established direct communication path by applying the determined transmission parameters for the transmitted emergency alert signal.

In this particular example, the determination of transmission parameters includes determining via which antenna panel the emergency alert signal is to be transmitted, i.e. via the back antenna panel 301a to the candidate vehicle 202, via the right-side antenna panel 301c to the right-hand candidate vehicle 204 and via the left-side antenna panel 301d to the left-hand candidate vehicle 203.

In a further embodiment, the ego vehicle 201 determines channel state information (CSI)—e.g. by evaluating a so-called channel matrix utilized to model a channel to a candidate vehicle—based on the received SRS of the respective candidate vehicle, which CSI may serve as a tool for estimating characteristics of the direct communication path established with each candidate vehicle in order to determine transmission parameters suitable for the particular characteristics of the direct communication path.

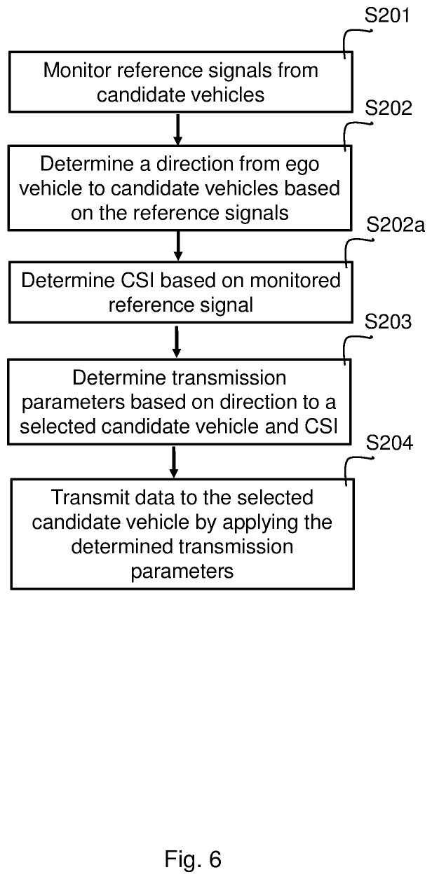

This is illustrated in FIG. 6, where in addition to determining direction to a candidate vehicle in step S202, CSI is further determined for the direct communication path to the candidate vehicle in step S202a.

Thereafter, in step S203, both the determined direction and the CSI is taken into account for determining the transmission parameters.

In an example, assuming that the CSI indicates that the braking alert signal to be transmitted over the direct communication path established with the candidate device 202 would benefit from being sent in a higher-frequency band rather than a lower-frequency band; in addition to transmitting the braking alert signal over the back antenna panel 301a, the signal is indeed sent in a higher-frequency band.

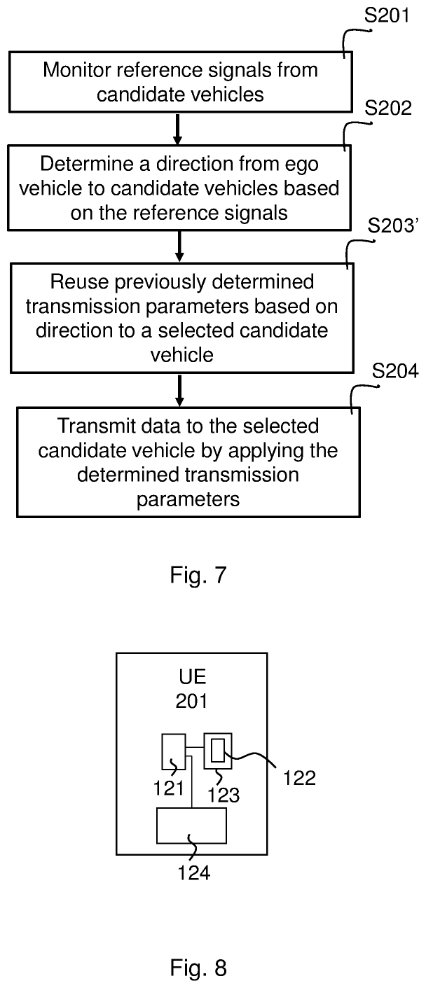

In yet an embodiment, with reference to FIG. 7, if a monitored SRS of a new candidate vehicle in step S201 would indicate that the new candidate vehicle is located in a same (or at least similar) direction relative to the ego vehicle 201 as a previous candidate vehicle as determined in step S202—e.g. by the candidate vehicle 202 located behind the ego vehicle 201 would be replaced by a new candidate vehicle—then the transmission parameters determined for the previous candidate vehicle may be reused for the new candidate vehicle in step S203′ and reapplied in step S204 upon transmitting data to the new candidate vehicle over a direct communication path.

As is understood, while the above embodiments describe a deployment where the ego vehicle 201 and the candidate vehicles 202, 203, 204 are served by the same RBS, it may be the case that the vehicles are located at an edge of a coverage area of the RBS, in which scenario the ego vehicle 201 may be served by a first RBS while one or more of the candidate devices are served by a neighbouring second RBS. If so, the first RBS and the second RBS may have to intercommunicate for a direct communication path to be established between vehicles located in different coverage areas.

FIG. 8 illustrates a UE 201 configured to perform direct communication with at least one other wireless candidate communication device in a wireless communication system according to an embodiment. The steps of the method performed by the UE 201 are in practice performed by a processing unit 121 embodied in the form of one or more microprocessors arranged to execute a computer program 122 downloaded to a suitable storage volatile medium 123 associated with the microprocessor, such as a Random Access Memory (RAM), or a non-volatile storage medium such as a Flash memory or a hard disk drive. The processing unit 121 is arranged to cause the UE 201 to carry out the method according to embodiments described herein, when the appropriate computer program 121 comprising computer-executable instructions is downloaded to the storage medium 123 and executed by the processing unit 121. The storage medium 123 may also be a computer program product comprising the computer program 122. Alternatively, the computer program 122 may be transferred to the storage medium 123 by means of a suitable computer program product, such as a Digital Versatile Disc (DVD) or a memory stick. As a further alternative, the computer program 122 may be downloaded to the storage medium 123 over a network. The processing unit 121 may alternatively be embodied in the form of a digital signal processor (DSP), an application specific integrated circuit (ASIC), a field-programmable gate array (FPGA), a complex programmable logic device (CPLD), etc. The UE 201 further comprises an interface 124 over which data may be received and transmitted.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of a wireless communication device (201) of performing direct communication with at least one other wireless candidate communication device (202) in a wireless communication system, comprising:
monitoring (S201) reference signals from wireless candidate communication devices (202, 203, 204);
determining (S202), from the monitored reference signals, a direction from said wireless communication device (201) to the wireless candidate communication device (202, 203, 204) associated with each monitored reference signal;
determining (S203) transmission parameters for data to be communicated to at least one selected wireless candidate communication device (202) of the wireless candidate communication devices (202, 203, 204) based on the determined direction to the selected wireless candidate communication device (202); and
transmitting (S204) data to the at least one selected wireless candidate communication device (202) over an established direct communication path by applying the determined transmission parameters for the transmitted data.

2. The method of claim 1, wherein the wireless candidate communication devices (202, 203, 204) being monitored are located in proximity of the wireless communication device (201).

3. The method of claim 1, wherein the wireless candidate communication devices (202, 203, 204) being monitored and the wireless communication device (201) are configured to be served by a common radio base station.

4. The method of claim 1, wherein the determining (S103) of transmission parameters for data to be communicated to the at least one selected wireless candidate communication device (202) comprises determining a direction in which to transmit the data to the at least one selected wireless candidate communication device (202).

5. The method of claim 1, wherein the reference signals being monitored comprise Sounding Reference Signals, SRSs.

6. The method of claim 1, further comprising:
determining (S201a) whether or not a strength of each monitored reference signal exceeds a signal strength threshold value, and if so determining (S202), from the monitored reference signals, a direction from said wireless communication device (201) to the wireless candidate communication device (202, 203, 204) associated with said each monitored reference signal.

7. The method of claim 1, further comprising:
determining (S202a) channel state information, CSI, for the direct communication path established with the at least one selected wireless candidate communication device (202), wherein the determining (S203) of transmission parameters for data to be communicated to at least one selected wireless candidate communication device (202) of the wireless candidate communication devices (202, 203, 204) further is based on the determined channel state information.

8. The method of claim 1, further comprising:
reusing (S203′) previously determined transmission parameters if the determined direction of a candidate communication device is similar to a previously determined direction of another candidate device.

9. The method of claim 1, the wireless communication device (201) being arranged with antenna panels (301a-d) being directed in different directions, wherein the direction to a wireless candidate communication device (202, 203, 204) is determined by evaluating on which one or more of the antenna panels (301a-d) a reference signal is received.

10. A computer program (122) comprising computer-executable instructions for causing a wireless communication device (201) to perform steps recited in claim 1 when the computer-executable instructions are executed on a processing unit (121) included in the wireless communication device (201).

11. A computer program product comprising a computer readable medium (123), the computer readable medium having the computer program (122) according to claim 10 embodied thereon.

12. A wireless communication device (201) configured to perform direct communication with at least one other wireless candidate communication device (202) in a wireless communication system, the wireless communication device (201) comprising a processing unit (121) and a memory (123), said memory containing instructions (122) executable by said processing unit (121), whereby the wireless communication device (201) is operative to:
monitor reference signals from wireless candidate communication devices (202, 203, 204);
determine, from the monitored reference signals, a direction from said wireless communication device (201) to the wireless candidate communication device (202, 203, 204) associated with each monitored reference signal;
determine transmission parameters for data to be communicated to at least one selected wireless candidate communication device (202) of the wireless candidate communication devices (202, 203, 204) based on the determined direction to the selected wireless candidate communication device (202); and to
transmit data to the at least one selected wireless candidate communication device (202) over an established direct communication path by applying the determined transmission parameters for the transmitted data.

13. The wireless communication device (201) of claim 12, being operative to monitor wireless candidate communication devices (202, 203, 204) located in proximity of the wireless communication device (201).

14. The wireless communication device (201) of claim 12 being operative to monitor wireless candidate communication devices (202, 203, 204) being served by a radio base station in common with the wireless communication device (201).

15. The wireless communication device (201) of claim 12 being operative to, when determining transmission parameters for data to be communicated to the at least one selected wireless candidate communication device (202), determine a direction in which to transmit the data to the at least one selected wireless candidate communication device (202).

16. The wireless communication device (201) of claim 12 wherein the reference signals being monitored comprise Sounding Reference Signals, SRSs.

17. The wireless communication device (201) of claim 12 further being operative to:
determine whether or not a strength of each monitored reference signal exceeds a signal strength threshold value, and if so to determine, from the monitored reference signals, a direction from said wireless communication device (201) to the wireless candidate communication device (202, 203, 204) associated with said each monitored reference signal.

18. The wireless communication device (201) of claim 12 further being operative to:
determine channel state information, CSI, for the direct communication path established with the at least one selected wireless candidate communication device (202), wherein the determining of transmission parameters for data to be communicated to at least one selected wireless candidate communication device (202) of the wireless candidate communication devices (202, 203, 204) further is based on the determined channel state information.

19. The wireless communication device (201) of claim 12 further being operative to:
reuse previously determined transmission parameters if the determined direction of a candidate communication device is similar to a previously determined direction of another candidate device.

20. The wireless communication device (201) of claim 12 being arranged with antenna panels (301a-d) being directed in different directions, wherein the direction to a wireless candidate communication device (202, 203, 204) is determined by evaluating on which one or more of the antenna panels (301a-d) a reference signal is received.
